(19) United States
(12) Patent Application Publication
(10) Pub. No.: US 2026/0077373 A1
(43) Pub. Date: Mar. 19, 2026

(54) NOZZLE ATTACHMENT ASSEMBLY, SYSTEM OF FLAT JET NOZZLE AND NOZZLE ATTACHMENT ASSEMBLY AND METHOD FOR JET PRESERVATION

(71) Applicant: Alfred Kärcher SE & Co. KG, Winnenden (DE)

(72) Inventor: Nicola BITAR, Montlingen (CH)

(21) Appl. No.: 19/397,411

(22) Filed: Nov. 21, 2025

Related U.S. Application Data
(63) Continuation of application No. PCT/EP2024/064517, filed on May 27, 2024.

(30) Foreign Application Priority Data
Jun. 1, 2023 (DE) 10 2023 114 472.3

(51) Int. Cl. B05B 15/65; B05B 1/04

(52) U.S. Cl. CPC B05B 15/65; B05B 1/044

(57) ABSTRACT

The invention relates to a nozzle attachment assembly including a connection element having a coupling point arranged on an end face for accommodating a flat jet nozzle, wherein a jet preservation element adjoins the connection element along an axial direction of extent of the nozzle attachment assembly and the jet preservation element includes an outlet opening in fluid-conducting connection with the coupling point by way of the interior of the nozzle attachment assembly, wherein the fluid-conducting connection is configured as an expansion zone that overall replicates a jet geometry of the flat jet nozzle such that a liquid jet formed having this jet geometry is continuously surrounded within the expansion zone by a peripheral gap in a radial direction, and wherein the connection element and/or the jet preservation element includes at least one gas inlet opening, which opens into the expansion zone.

### CROSS-REFERENCE TO RELATED APPLICATIONS

This application is a continuation of international application number PCT/EP2024/064517, filed on May 27, 2024, and claims the benefit of German application number 102023114 472.3, filed on June 1, 2023, which are incorporated herein by reference in their entirety and for all purposes.

### BACKGROUND OF THE INVENTION

The present invention relates to a nozzle attachment assembly, a system of flat jet nozzle and nozzle attachment assembly, and a method for jet preservation of a liquid jet exiting a flat jet nozzle.

Liquid-operated high-pressure cleaners are known and are used, for example, for cleaning soiled surfaces or for removing varnish and paint residue from surfaces. To this end, liquid is conveyed at a high pressure by means of a high-pressure compressor to an outlet nozzle at which the liquid exits the high-pressure cleaner. The exit hereby takes place in a jet shape that is largely influenced by the nozzle. Water or water mixed with a cleaning agent is often used as the liquid. Commencing from the nozzle, the liquid jet then moves toward the surface to be cleaned, wherein the kinetic energy stored in the liquid particles of the liquid jet exerts its cleaning effect when it impinges on the surface to be cleaned. A flat jet nozzle typically consists of a housing that can be connected to a high-pressure cleaner or another high-pressure source. Within the housing there is an opening, which is shaped such that it forces the liquid jet into a flat, fan-shaped form. This is achieved by the pressure being built up within the nozzle and then being conducted through a narrow, elongate opening, the so-called flat jet gap. Here, the liquid is shaped into a continuous, even flat jet. As soon as the liquid approaches a nozzle outlet opening, the diameter of the liquid jet flow is reduced. The liquid is hereby greatly accelerated and exits the nozzle at high speed to produce the high-pressure jet.

The problem here is that the transmittable kinetic energy and thus the cleaning power of the liquid jet decreases with increasing distance of the nozzle from the surface to be cleaned. This effect is already noticeable when cleaning in the air, because air, despite its comparatively low density, hinders the movement of the liquid jet and leads to a significant dispersion of the liquid jet after only a few centimeters. This applies particularly if a cleaning is to take place in a significantly more dense/viscous medium. If the liquid jet is used, for example, under water to clean a surface, then there is already a noticeable reduction in the cleaning power after significantly shorter distances from the surface to be cleaned that the liquid jet has to overcome (compared to air).

Until now, to solve this problem, the kinetic energy stored in the water jet was frequently increased by using more powerful compressors in order to be able to provide the require cleaning power in the respective application. However, this approach has economic and technical limitations.

In accordance with an embodiment of the invention, provision is made to increase the cleaning power of a liquid-operated high-pressure cleaning system in a cost-effective and energy-efficient manner.

### SUMMARY OF THE INVENTION

In accordance with an embodiment of the invention, a nozzle attachment assembly is provided having the features of the independent claim 1 and a system is provided having the features of the independent claim 11. Furthermore, a method is provided having the features of the independent claim 14.

Advantageous embodiments and further developments result from the dependent claims.

A nozzle attachment assembly is described comprising a connection element having a coupling point arranged on an end face for accommodating a flat jet nozzle of a liquid-operated high-pressure cleaner, wherein a jet preservation element adjoins the connection element along an axial direction of extent of the nozzle attachment assembly, wherein the jet preservation element comprises an outlet opening on an outlet side facing away from the end face, said outlet opening being in fluid-conducting connection with the coupling point by way of the interior of the nozzle attachment assembly, wherein the fluid-conducting connection is configured as an expansion zone, which is delimited in a first plane perpendicular to the axial direction of the extent by cover walls that have a distance h and which is delimited by side walls in a second plane that is perpendicular to the first plane, such that the expansion zone overall replicates a jet geometry of the flat jet nozzle that is able to be accommodated in such a way that a liquid jet formed having this jet geometry is continuously surrounded within the expansion zone by a peripheral gap in a radial direction perpendicular to the axial direction of extent, and wherein the connection element and/or the jet preservation element comprises at least one gas inlet opening, which opens into the expansion zone. The at least one gas inlet opening may hereby have a filter or shielding device if necessary to prevent the ingress of foreign particles or contaminants, which could negatively influence the intake of gas. The outlet opening may be substantially rectangular, but may also have slightly rounded corners. In particular, the two short sides may also be slightly curved. The ratio of the short sides to the long sides of the outlet opening may be at least 1:10, for example. The expansion zone may assist in the expansion of the liquid jet, for example by a factor of 20 (in the jet width) along the axial direction of extent, i.e., from the outlet of the flat jet nozzle to the outlet opening of the nozzle attachment assembly.

The distance h may be constant or at least substantially constant. It is also possible, however, that the distance h between the two cover walls increases or decreases in the axial direction of extent seen from the flat nozzle, wherein the increase and decrease can be identified with an opening or closing angle. In particular, the increase or decrease in this context may take place evenly/uniformly, such that a symmetry plane can be found in which the axial direction of extent can extend. The opening or closing angle may preferably be constant. Such a variation of the distance h or the provision of an opening/closing angle can bring about an additional shaping of the jet in the expansion zone as necessary, because these changes first cause a change in the uniformity of the gas flow and as a direct consequence also cause a change in the jet shaping.

By means of this nozzle attachment assembly, when it is coupled to the flat jet nozzle and the liquid jet exiting the flat jet nozzle, in its intended geometry, resembles the dimensions of the expansion zone in the nozzle attachment assembly in the described manner, the jet geometry of the liquid jet, after exiting the flat jet nozzle and after the liquid jet has passed through the jet preservation element of the nozzle attachment assembly, is able to be advantageously preserved over a greater path/distance. The term “path” or “distance” is hereby understood to mean, for example, the distance from the flat nozzle at which the liquid jet is produced by the flat nozzle at which the “liquid” is being viewed. In particular, the typical dispersion/atomization of the liquid jet at the medium, for example water or air, through which said jet passes can be greatly reduced.

This effect is achieved by means of the gas, which is able to enter or be drawn via the gas inlet opening into the expansion zone. Due to the design, the liquid jet does not substantially contact the expansion zone when passing through the jet preservation element and is at a uniform distance from the cover and side walls delimiting the expansion zone all around in a radial direction, such that a peripheral gap with a substantially constant width is formed between the liquid jet and an expansion zone wall. The liquid jet that flows through the expansion zone draws gas through the gas inlet opening according to the principle of a water jet pump, said gas entering into the expansion zone and being entrained by the liquid jet. Here, a uniform gas flow forms around the liquid jet in the gap between the surface of the liquid jet and the cover walls and the side walls of the expansion zone, which gas flow completely envelopes the liquid jet even after exiting the outlet opening and advantageously delays a dispersion of the formed liquid jet after exiting the outlet opening. The uniform gas flow that is created thus prevents or delays an undesired atomization or “thickening” of the flat jet produced by the flat jet nozzle during the expansion of the flat jet in the nozzle attachment assembly. The term “uniform” may be understood to mean, but not limited to, a gas flow that has at least some properties of a laminar gas flow or of a turbulence-free gas flow. Due to the mechanism of action, the gas that is drawn in is not sucked into the liquid jet, but instead is accelerated on the surface thereof in the flow direction of the liquid. Although a portion of the kinetic energy contained in the liquid jet is used for the intake of the gas and the liquid just is thus even somewhat slower when it flows out of the nozzle attachment assembly (compared to a (structurally identical) system without a nozzle attachment assembly), the better bundling of the liquid jet (flat jet with a reduced thickness with identical width) achieves a higher cleaning power on the surface to be cleaned. A proportion of the kinetic energy extracted from the liquid jet hereby remains in the liquid jet in the form of (waste) heat, experiments having shown a measured warming of the liquid jet of 1 to 2 °C with the used test system with the described nozzle attachment assembly. This temperature increase benefits the increase in cleaning performance because warmer liquids typically clean better than colder ones. By using the described nozzle attachment assembly, an energy and liquid savings of 50% in each case can be achieved compared to a conventional system without such an assembly. In addition, the greatly increased cleaning performance can also save a great amount of working time.

The intake gas may be air or another gas, for example. It may be conceivable to suck in water vapor, for example, to increase the cleaning performance. Within the nozzle attachment assembly, more precisely when passing through the expansion zone, the flat jet produced by the nozzle is corrected in its shape by the intake air that forms the uniform boundary layer, without the flat jet substantially contacting the nozzle attachment assembly. Here, undesired deviations from the intended jet geometry created by the flat jet nozzle are compensated/reduced. The corrected flat jet is not influenced in its developing width, but instead remains more compact in its “thickness” and at the same time more uniform over its width. The process could also be referred to as “recompaction”. The correction of the jet geometry within the expansion zone of the nozzle attachment assembly is the main function that contributes the greatest amount to the increased cleaning performance. The surprising effect is that the gas remains between the different flow speeds of the surrounding medium/wall of the nozzle attachment assembly and the liquid jet and forms a stable gas cushion that optimally separates and hereby forms a uniform gas flow. The energy loss of the flat jet during its expansion is therefore reduced and the flat jet remains more concentrated/compact. The uniform gas flow that forms on the surface of the liquid jet also constitutes a sort of gas curtain, which further shields the liquid jet after its exit from the nozzle attachment assembly from the dissipating effect of the surrounding medium. The gas curtain can also be seen as a sort of separating curtain. In the uniform boundary layer between air jet and water jet, the speed difference between air and water can cause a rotation of the liquid droplets detaching there from the liquid jet in a mist-like manner. When such a liquid droplet set into rotation strikes the surface to be cleaned, said droplet produces an increased cleaning effect, because local shear forces act on the dirt to be removed.

The nozzle attachment assembly enables a more efficient high-pressure cleaning under otherwise identical parameters, wherein in particular under water an improvement in cleaning power of about 500% can be achieved compared with a system without any jet shaping assembly. The increase in cleaning power hereby correlates with the length of the nozzle attachment assembly in the axial direction of extent. The longer the flat jet is guided in its expansion in the nozzle attachment assembly, the more power the flat jet has compared to a conventionally expanding flat jet. The nozzle attachment assembly may be configured as an attachment accessory for an existing high-pressure cleaning system with a flat jet nozzle.

The rectangular pyramidal or truncated pyramid-shaped flat jet is separated from the surrounding medium by the nozzle attachment assembly during its initial expansion. In addition, gas that is drawn in from the outside is entrained/sucked along at the rim of the flat jet. The medium is thus also not able to penetrate into the nozzle attachment assembly. The entrained gas causes a physical effect that positively influences the liquid jet, or its further spatial expansion, in the medium. In addition, the uniform gas flow forms a gas cushion when exiting the nozzle attachment assembly, such that a present effective average density of a considered spatial volume that contains both liquid, in particular water, and gas, for example air, is massively reduced. This reduction occurs in particular at the edge of the liquid jet. An additional increase in cleaning power is achieved, because the high-pressure jet is decelerated to a lesser degree due to the density reduction. A further effect of the described nozzle attachment assembly is that the highly uniform accelerated sliding air that is created during operation between the flat jet and the side and/or cover walls upon exiting the nozzle attachment assembly is again greatly decelerated and thereby undergoes a spatial expansion. This causes the flat jet to remain more compact for longer than usual, even outside of the nozzle attachment assembly, compared to an unprotected expansion. A more compact flat jet necessarily means a better cleaning performance. The term “more compact flat jet” refers mainly to a height extent or thickness of the flat jet and only to a slight degree to a width of the flat jet.

The liquid jet that is formed thus remains “focused” with the intended jet geometry for longer, such that less of the kinetic energy contained in the liquid jet is transmitted to the surrounding medium, for example air or water, while the liquid jet is striking a surface to be cleaned commencing from the outlet opening.

Ultimately it is thus possible to transmit more energy per unit area to the surface to be cleaned with equal power introduced into the liquid jet. Alternatively, with a system that uses the nozzle attachment assembly, the same cleaning effect can be achieved as with a system without a nozzle attachment assembly, but with a lower labor demand. By means of the described nozzle attachment assembly, a system comprising the flat jet nozzle and the nozzle attachment assembly arranged thereon thus becomes more powerful under otherwise identical parameters or, alternatively, with respect to the cleaning effect that is able to be achieved, more efficient with an identical cleaning effect. Mixed states between these two extremes are also able to be set, there being a trade-off between efficiency and cleaning power. Furthermore, using the nozzle attachment assembly, it is no longer possible to get too close to a cleaning object and damage the cleaning object with a jet that is too powerful, because the dimensions of the nozzle attachment assembly already ensure a sufficient physical distance. Moreover, the described nozzle attachment assembly reduces the recoil that a user of a high-pressure cleaning system has to absorb when guiding the flat nozzle when the nozzle attachment assembly is used.

Furthermore, it may also be possible to forgo an additional gas supply by means of a gas pressure generator, for example a pressurized air generator. By way of its design, the described nozzle attachment assembly is “self-priming” for the required gas volume. Accordingly, it is possible to completely forgo gas supply systems.

The chosen term coupling point, in the present documents, can be understood to include the location of any fastening device known to the person skilled in the art, which, for example, achieves the fastening of the nozzle attachment assembly to the flat jet nozzle in a force-locking or positive-locking manner. The fastening of the nozzle attachment assembly at the attachment point may hereby take place, in particular, in a force-locking or positive-locking manner by means of the fastening device. A positive-locking fastening can be achieved, for example, with a bayonet closure. A force-locking fastening can be achieved, for example, by means of a clamping closure. More complex fastening mechanisms are possible. The term flat jet nozzle can be understood within the context of the present application documents to mean a nozzle, which shapes fed liquid to a liquid jet that has a fixed jet geometry determined by the nozzle at least in a vicinity of the flat jet nozzle. This jet geometry in a flat jet nozzle is given by a fan-shaped jet shaping, wherein the shaped jet widens along the axial direction of extent, which coincides with the flow direction of the liquid. Here, the flat jet shaped by the nozzle has in the first plane perpendicular to the axial direction of extent a thickness that is as constant as possible and in the second plane perpendicular to the first plane has lateral rim regions, which can be described by an opening angle commencing from a nozzle outlet point, such that the rim regions of the formed jet diverge uniformly in the axial direction of extent with increasing distance from the nozzle outlet opening. The axial direction of extent is thus the direction in which the flat jet nozzle forms the flat jet and simultaneously the direction in which the nozzle attachment assembly mainly extends.

The flat jet nozzle is a special nozzle, shapes the liquid jet into a flat and wide rectangular pyramidal or truncated pyramid-shaped form. A typical flat jet nozzle produces a flat liquid jet that is rectangular in the front view and expands. The expansion is uniform and occurs in the “width” with an angle of at least 15°. The flat jet nozzle is typically designed such that is produces a certain angle between the two outer edges of the flat jet, which may vary depending on the application and model (at least 15° and at most 145° opening angle in width). The flat jet with an opening angle of at least 15° describes geometrically a bundled liquid jet that is output in the form of a fan having an opening angle of at least 15 degrees in width (or area). The flat jet is thus wider than a (bundled) point jet but narrower than a point jet with a larger lateral opening angle, the flat jet being symmetrical in width. In geometry, such a shape is also described as a rectangular pyramid. The term “flat jet” in the context of the present application documents thus refers to a jet that is forced into a flat, wide shape, the expansion of which is fan-shaped. In general, a flat jet is understood to mean that the jet has an opening with an angle of 15 degrees or more.

The flat jet shaped by the flat jet nozzle has a thickness of about 0.6 mm, for example, upon exiting the nozzle. After a distance of 200 mm, the flat jet shaped by the flat jet nozzle already has a thickness of about 4 mm. The jet thus diverges. The flat jet shaped by the same flat jet nozzle then, after flowing through the nozzle attachment assembly and thereby being corrected in its shape, has, for example, only a thickness of about 2 mm after the same traversed distance of 200 mm, wherein a compressor power of about 2.8 kW is assumed in all cases. The nozzle attachment assembly can thus significantly improve the jet geometry in its compactness. In other words, a jet geometry actually achieved by the flat nozzle is improved toward an ideally intended jet geometry when the flat nozzle is used together with the nozzle attachment assembly. When using the nozzle attachment assembly, a significant amount if gas is drawn in via the gas inlet opening by the flat jet, somewhat more than 90 liters per minute having been measured in experiments with a tested system.

To improve handling, the nozzle attachment assembly may comprise rollers on its outlet side to assist in even guidance on the surface to be cleaned.

The connection element and the jet preservation element may be integrally connected to one another, in particular formed in one piece with one another. It is conceivable that the one element is fixedly molded on the other element or that both elements are produced separately from one another and are then fixedly connected to one another. The term “fixedly connected” may be understood to mean, for example, releasable or no longer releasable in a non-destructive manner or materially bonded. Material bonds include, in particular, fusion, welding, soldering, and adhesion. The optionally fan-shaped expansion zone can be seen, in particular, as a “negative” of the formed flat jet, such that the distance h between the formed flat jet and the side walls and cover walls delimiting the expansion zone can be considered substantially constant. The radial direction can be understood in the context of the present application documents to mean the typical radial direction in cylindrical coordinates, wherein the axial direction of extent in cylindrical coordinates corresponds to the typical Z-axis and the radial direction lies in any position perpendicular to the axial direction of extent and additionally can be rotated by a rotation angle φ (in cylindrical coordinates) about the axial direction of extent. The radial direction hereby always extends away from the axial direction of extent.

Provision may usefully be made that the at least one gas inlet opening is closable or adjustable. The closability of the at least one gas inlet opening can be achieved, for example, by means of a suitable closure flap or a suitable closure mechanism, wherein in particular a partial closure of the at least one gas inlet openings can also be achieved, for example by means of an adjustable slider. A partial closure can thus be associated with the term “adjustable”. By closing or partially closing the at least one gas inlet opening, the amount of gas drawn into the expansion zone by the liquid jet can be influenced under otherwise identical parameters, it thereby being possible in a simple manner to control the cleaning power by adapting the gas amount. When using the nozzle attachment assembly in an underwater environment, as an effect that is visually easy to perceive, the intensity of the formed gas curtain is also reduced due to the reduced amount of gas that is drawn in, such that ultimately fewer gas bubbles envelop the formed liquid jet after exiting the nozzle attachment assembly. The gas bubbles and the underwater environment regularly have greatly differing refraction indices and thus form an opaque curtain around the liquid jet due to the boundary layers created, said curtain impairing the direct view of the point of impact on the surface to be cleaned. By sufficiently reducing the number of gas bubbles, an improved view of the surface to be cleaned than thus be achieved as necessary. Furthermore, by closing the gas inlet opening, the air cushion can be replaced by a vacuum, such that the nozzle attachment assembly can suck against the surface to be cleaned due to the Bernoulli effect.

Provision may further be made that the at least one gas inlet opening opens into the expansion zone at at least two openings separated from one another, wherein at least one opening is provided on each cover wall. By providing two openings separated from one another at which the gas inlet opening opens into the expansion zone, gas can be drawn in by the formed liquid jet on each “side” thereof. As a result, a uniform gas flow is formed in each case on the two opposing flat sides of the formed liquid jet, such that the formed liquid jet is uniformly enveloped by the uniform gas flow in the expansion zone in substantial parts, namely the two flat sides. The size and shape of the at least two openings separated from one another and their connection to the at least one gas inlet opening may hereby be designed in such a way that on opposite sides the same volumes of gas are drawn in per unit of time, and that the uniform gas flow that is formed, which may also be seen as a gas curtain, reaches equal thicknesses in the vicinity of the outlet opening on the two flat sides of the liquid jet. The at least two openings separated from one another are thus each specially designed in their respective sizes, shapes and connections to the at least one gas inlet opening such that the same amount of gas is able to be drawn in to reshape the already formed flat jet in its form in the expansion zone, such that the intended shape is maintained longer. Two openings of the at least two openings may hereby be arranged on the rim of the cover sides pointing toward the flat jet nozzle and here may “notch” into the cover side. The openings may hereby be positioned each located opposite one another, for example, wherein in particular this positioning may then have a certain symmetry, for example a mirror symmetry on the axial direction of extent.

In this context, provision may advantageously be made that the at least one gas inlet opening opens into the expansion zone at at least four openings, wherein at least one opening is provided on each cover wall and furthermore at least one opening is provided on each side wall. In this way, the liquid jet formed by the flat jet nozzle can be supportively reshaped in its shape on its flat sides. Provision may hereby be made that the at least four openings are openings separated from one another. Here, it is also possible that two openings arranged on the opposing side walls are arranged symmetrically to one another in a particular way.

Provision may further be made that the side walls diverge in the axial direction of extent, such that the expansion zone widens in the shape of a fan. In this way, the expansion zone can more precisely replicate the jet geometry, the peripheral gap between the liquid jet and the walls surrounding it thereby having a more uniform width along the axial direction of extent. This leads to an improvement of the lateral spreading of the flat jet, such that, as the case may be, a slightly wider flat jet can be created by the same flat jet nozzle, which in turn can speed up the cleaning of a surface, because the jet has to be moved less frequently/far to pass over the entire area.

Provision may also be made that provided on each of the opposing cover walls is at least one structuring projection, which locally reduces the distance h between the cover walls. The at least one projection creates a “ground effect”, which if designed/shaped appropriately can be used to homogenize the flat jet in its thickness over its width. The positive or negative ground effect that is created hereby produces an additional pressure gradient in the gas that is flowing by, which in turn attracts or repels liquid of the liquid jet. In this way, for example experimentally, a flat jet can be created that is particularly homogeneous over its entire width, which thus also provides a particular uniform cleaning power. The exact position and shape of the at least one projection on the cover walls can be varied as necessary. Here, it is also possible, in particular, that a plurality of projections are arranged simultaneously at different points on the opposing cover walls. Provision may hereby be made, for example, that projections on the opposing cover walls are designed symmetrically to one another in pairs and have equal dimensions, for example. Thus, a symmetrical equal “counterpart” (an associated projection on the opposite cover wall) can always be present. For the purpose of explanation, it should be noted here that any conventional flat jet nozzle produces an uneven flat jet due to its design, the flat jet having an inhomogeneous power distribution over its width. Thus, typically more power is transmitted in the jet center onto a target area than in the two rim regions, because more liquid flows in the jet center despite the flat jet shape. This problem is solved with the help of the at least one structuring projection, because said projection can “contactlessly” guide liquid from the jet center to the rim regions during the expansion of the flat jet.

In this context, provision may additionally be made that the projections are adjustable in their orientation within the expansion zone. The term orientation in the scope of these application documents may hereby be understood to mean both their (average) height compared to the unstructured remaining cover wall and an angular adjustment of the individual surface of the projections (angle of attack). Such an adjustability can be achieved, for example, by means of one or more adjusting means, in particular accessible from the outside, for example screws. The adjusting means, for example, can hereby move an, in particular planar, surface of the projections facing toward the expansion zone in a continuous or stepped manner.

Provision may usefully be made that openings provided on the opposing cover and/or side walls are each arranged symmetrically to one another in pairs. By arranging the provided openings on the respective opposing cover and/or side walls symmetrically to one another in pairs, a centering of the formed liquid jet in the interior of the nozzle attachment assembly is promoted or supported by means of the gas drawn in, such that small undesired or unintended angular deviations between the axial direction of extent of the nozzle attachment assembly and the outflow direction of the liquid jet out of the flat jet nozzle are able to be compensated or at least reduced. Furthermore, by symmetrically arranging the openings on the respective opposing cover and/or side walls, the dispersion of the liquid jet can be counteracted uniformly and, in particular, from all sides.

Provision may also be made that provided on each of the opposing cover walls in the axial direction of extent are a plurality of openings, the respective width of which increases with increasing distance from the connection element. By providing a plurality of openings on the opposing cover walls in the axial direction of extent, it is possible to act in multiple instances on the wide sides of the liquid jet formed by the flat jet nozzle in a manner that supports its shape, such that the compactness and stability of the formed liquid jet upon exiting the nozzle attachment assembly at the outlet opening is further improved. The additional air inlets in the expansion zone prevent, in particular, the development of a high negative pressure, which increases constantly along the axial direction of extent. Such a high increasing negative pressure would, in the case of an expansion zone extended in the axial direction of extent, “suck” the liquid jet against the cover walls and thus cause “rubbing”. This rubbing in turn would trigger vortexes in the flat jet, which would cause the jet to dissipate more quickly after exiting the expansion zone. An additional secondary effect of the further openings is that the jet when exiting the expansion zone is only about half as thick (in the direction between the two cover walls as it would be without the use of the nozzle attachment assembly). This circumstance ultimately causes an even further improved cleaning performance, because the exiting flat jet is again more focused. By the areas of the individual openings increasing with increasing distance from the connection element, the increasing width of the fanning out flat jet can be accounted for. By providing a plurality of additional openings on the opposing cover walls, a significant further increase in cleaning performance can be achieved. Thus, with a jet width of 70 mm (at the nozzle outlet), an at least 50% increase in cleaning power can be achieved when used in air as the surrounding medium. With the additional openings, an increase in cleaning power of at least 1000% can be achieved in the case of an underwater application (compared to a system without any nozzle attachment assembly). By introducing or omitting openings at certain points, i.e., by positioning openings in a targeted manner, along the axial direction of extent, an uneven water jet power distribution caused by the flat jet nozzle can be “homogenized”, such that when the flat jet is emitted, the cleaning power is more uniform over the entire extent, i.e., the width, of the flat jet. Here, an optional positioning of the openings for a special flat jet nozzle can be determined by experiment, for example.

Provision may also usefully be made that gas inlet openings are provided on the connection element. By providing gas inlet openings on the connection element, the gas supply, for example, can be arranged in the direct vicinity of the coupling point, so that the gas supply can be arranged as far away from the outlet opening as possible, in particular on the end face of the connection element. This reduces the risk that liquid of the liquid jet exiting the nozzle attachment assembly splashes back via the gas inlet openings after striking a surface to be cleaned and negatively influences the function of the nozzle attachment assembly. Furthermore, in an underwater application, the gas supply via the gas inlet openings can be advantageously combined with the attachment of the flat jet nozzle to the nozzle attachment assembly.

By arranging gas inlet openings on the jet preservation element, suction paths from the gas inlet openings to the openings in the expansion zone are able to be made short, which can improve the suction effect of the formed liquid jet in the expansion zone. In this way, the gas curtain that is formed can thus be increased in its intensity.

Provision may further be made that the connection element comprises an elastic material. By means of the elastic material, a fastening of the nozzle attachment assembly to the flat jet nozzle is possible in a simple manner, for example by the nozzle attachment assembly comprising a peripheral elastic sealing lip, which can be slid over the flat jet nozzle counter to the axial direction of extent, said sealing lip thereby fixing the flat jet nozzle to the nozzle attachment assembly at its coupling point in a clamping and liquid-sealing manner.

Provision may further be made that a gas supply conduit is connectable to the at least one gas inlet opening. In this way, gas that is able to be drawn in at the at least one gas inlet opening is able to be provided even in the case of an underwater application, said gas being able to be drawn into the expansion zone by means of the formed liquid jet. It is also possible that gas is actively conveyed by way of the connectable gas supply conduit in the direction toward the at least one gas inlet opening, for example by means of a cooling blower of a compressor of the liquid-operated high-pressure cleaner. This can be advantageous in particular in the case of a longer gas supply conduit, because the suction effect of the liquid jet is limited and after a longer gas supply conduit may no longer be sufficient to intake a sufficient amount of gas without support.

Provision may usefully be made that the jet preservation element is able to be assembled modularly from a plurality of individual elements, wherein the plurality of individual elements are connectable to one another in the axial direction of extent. In this way, a length of the jet preservation element in the axial direction of extent can be adapted depending on the application, wherein reference is made in this regard to the fact that by extending the jet preservation element in the axial direction of extent, the expansion zone is always also extended in this direction, such that the liquid jet is then guided over a longer path and is correctively reshaped by means of the uniform gas layer. Provision may hereby be made that the modularly connectable individual elements differ from one another, in particular in their respective dimensions, and thus a fixed order must be followed when connecting them to one another.

Furthermore, a system is described comprising a flat jet nozzle, which is set up to shape supplied liquid to form a flat jet having a jet geometry, and comprising a nozzle attachment assembly adapted to said jet geometry, as described above. A method is also described for the jet preservation of a liquid jet exiting a flat jet nozzle, wherein the liquid jet is enveloped by a gas curtain using a nozzle attachment assembly of that kind.

In this way, the advantages and special features of the described nozzle attachment assembly are also achieved in the scope of a system and a method for jet preservation.

In the described system, provision may usefully be made that the flat jet nozzle is formed in one piece with the nozzle attachment assembly. For example, it is conceivable that the flat nozzle and the connection element are fixedly molded on one another or that both elements are produced separately from one another and are then fixedly connected to one another. The term “fixedly connected” may be understood to mean, for example, releasable or no longer releasable in a non-destructive manner or materially bonded. Material bonds include, in particular, fusion, welding, soldering, and adhesion.

Provision may further be made that a component of the flat jet nozzle forms a connection element of the nozzle attachment assembly. The system can be configured particularly compactly in this way.

Here, too, there are further advantageous embodiments and further developments each building on the further developments of the nozzle attachment assembly described above.

### BRIEF DESCRIPTION OF THE DRAWINGS

FIG. 1 shows a simplified three-dimensional outer depiction of a first nozzle attachment assembly and a flat jet nozzle from a first viewing direction;

FIG. 2 shows the nozzle attachment assembly depicted in FIG. 1 and the flat jet nozzle from a second viewing direction;

FIG. 3 shows the nozzle attachment assembly depicted in FIG. 1 and the flat jet nozzle in a sectional depiction along a first plane;

FIG. 4 shows the nozzle attachment assembly from FIG. 1 and the flat jet nozzle in a sectional depiction along a second plane;

FIG. 5 shows a simplified three-dimensional outer depiction of a second nozzle attachment assembly from a first viewing direction;

FIG. 6 shows the second nozzle attachment assembly from FIG. 5 from a second viewing direction;

FIG. 7 shows the second nozzle attachment assembly from FIG. 5 in a sectional depiction along the first plane;

FIG. 8 shows the second nozzle attachment assembly in a sectional depiction along the second plane;

FIG. 9 shows a simplified three-dimensional outer depiction of a third nozzle attachment assembly from a first viewing direction;

FIG. 10 shows the third nozzle attachment assembly from FIG. 9 from a second viewing direction;

FIG. 11 shows the third nozzle attachment assembly in a sectional depiction along the first plane;

FIG. 12 shows the third nozzle attachment assembly in a sectional depiction along the second plane;

FIG. 13 shows a simplified three-dimensional outer depiction of a fourth nozzle attachment assembly from a first viewing direction;

FIG. 14 shows the fourth nozzle attachment assembly from FIG. 13 from a second viewing direction;

FIG. 15 shows the fourth nozzle attachment assembly in a sectional view along the first plane;

FIG. 16 shows the fourth nozzle attachment assembly in a sectional view along the second plane;

FIG. 17 shows a simplified three-dimensional outer depiction of a fifth nozzle attachment assembly from a first viewing direction;

FIG. 18 shows the fifth nozzle attachment assembly from FIG. 17 from a second viewing direction;

FIG. 19 shows the fifth nozzle attachment assembly in a sectional view along the first plane;

FIG. 20 shows the fifth nozzle attachment assembly in a sectional view along the second plane; and

FIG. 21 shows a flow diagram of an exemplary method.

### DETAILED DESCRIPTION OF THE INVENTION

In the following description of the drawings, the same reference numerals refer to identical or comparable components.

FIG. 1 shows a simplified three-dimensional outer depiction of a first nozzle attachment assembly 10 and a flat jet nozzle 20 from a first viewing direction. The nozzle attachment assembly 10 depicted has an axial direction of extent 24. A flat jet nozzle 20 is depicted spaced at a distance from the nozzle attachment assembly 10 in the axial direction of extent 24. The flat jet nozzle 20 itself comprises a flat jet nozzle outlet opening 64 at which liquid supplied to the flat jet nozzle 20 is able to exit in the form of a formed liquid jet.

The nozzle attachment assembly 10 comprises a connection element 12 on a side facing toward the flat jet nozzle 20. The connection element 12 is adjoined by a jet preservation element 14 on the side of the nozzle attachment assembly 10 facing away from the flat jet nozzle 20. The jet preservation element 14 is fixedly connected to the connection element 12 and, for example, may be formed in one piece therewith or one may be configured to be fixedly molded on the other. A plurality of gas inlet openings 50 can be seen on the connection element 12 in FIG. 1, wherein two further gas inlet openings 50 are arranged, symmetrically to the two gas inlet openings 50 that are visible in FIG. 1, on the regions that are not visible in FIG. 1, i.e., the rear side and the bottom side of the connection element 12, such that in the case of the first nozzle attachment assembly 10 depicted in FIG. 1, a total of four gas inlet openings 50 are provided peripherally perpendicular to the axial direction of extent 24, said gas inlet openings being arranged peripherally with each being rotated by 90° about the axial direction of extent 24 as a rotational axis. Said gas inlet openings 50 are connected to gas channels, which are not specified further and which extend into the interior of the nozzle attachment assembly. The jet preservation element 14 comprises an outlet side 26 with an outlet opening 28 on the side opposite the connection element 12.

When the flat jet nozzle 20 is connected to the connection element 12 of the nozzle attachment assembly 10 or is fixedly but releasably connected thereto, a liquid jet formed by the flat jet nozzle 20 first enters in the axial direction of extent 24 at the connection element 12 into the nozzle attachment assembly 10, travels therethrough, and finally exits the jet preservation element 14 of the nozzle attachment assembly 10 at the outlet opening 28. The inner geometry of the nozzle attachment assembly 10 is hereby designed in such a way that the formed liquid jet substantially does not contact an inner side of the nozzle attachment assembly 10 when the latter is correctly mounted on the flat jet nozzle 20, but rather forms a substantially constant gap from the inner side of the nozzle attachment assembly. The term “does not contact” is hereby understood to mean that a surface of the liquid jet determined by the jet geometry is considered and said surface does not “collide” with the nozzle attachment assembly. Individual liquid particles or droplets that may detach from this surface in the form of a mist are not taken into consideration. Also shown in FIG. 1 is a radial direction 46, which in cylindrical coordinates denotes a radial vector that can be rotated perpendicularly to the axial direction of extent 24 and locally about a rotation angle φ and thereby lies in any angular position perpendicular to the axial direction of extent 24.

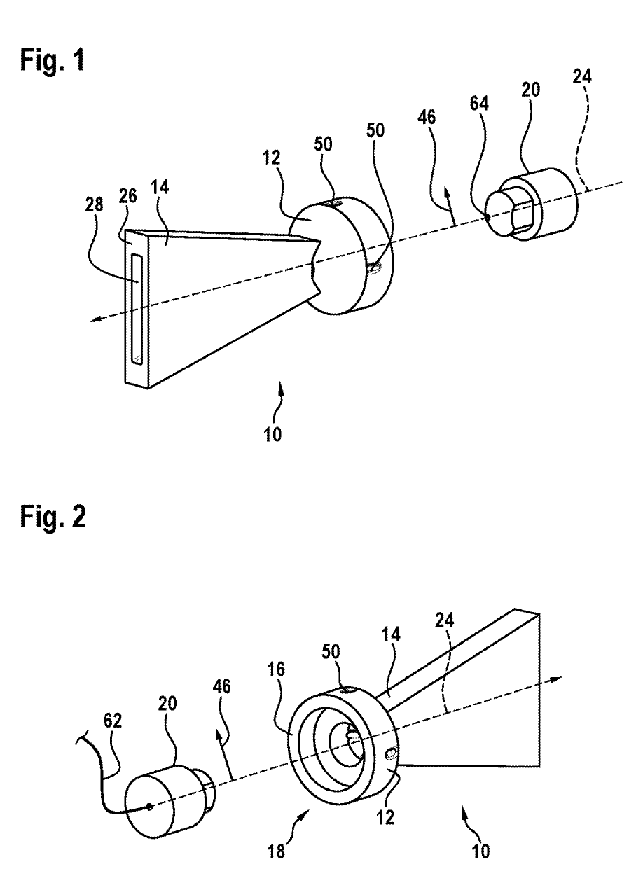

FIG. 2 shows the first nozzle attachment assembly 10 according to FIG. 1 from another perspective, such that in FIG. 2 in particular a coupling point 18 on an end face 16 of the nozzle attachment assembly 10 is visible. When joining the flat jet nozzle 20 with the nozzle attachment assembly 10, the nozzle attachment assembly 10 is slid counter to the axial direction of extent 24 onto the flat jet nozzle 20 in such a way that it is clampingly held on the surface of the flat jet nozzle 20. Furthermore, a liquid supply conduit 62 is also indicated in FIG. 2, by way of which the liquid required for forming the jet, for example water, is supplied to the flat jet nozzle 20.

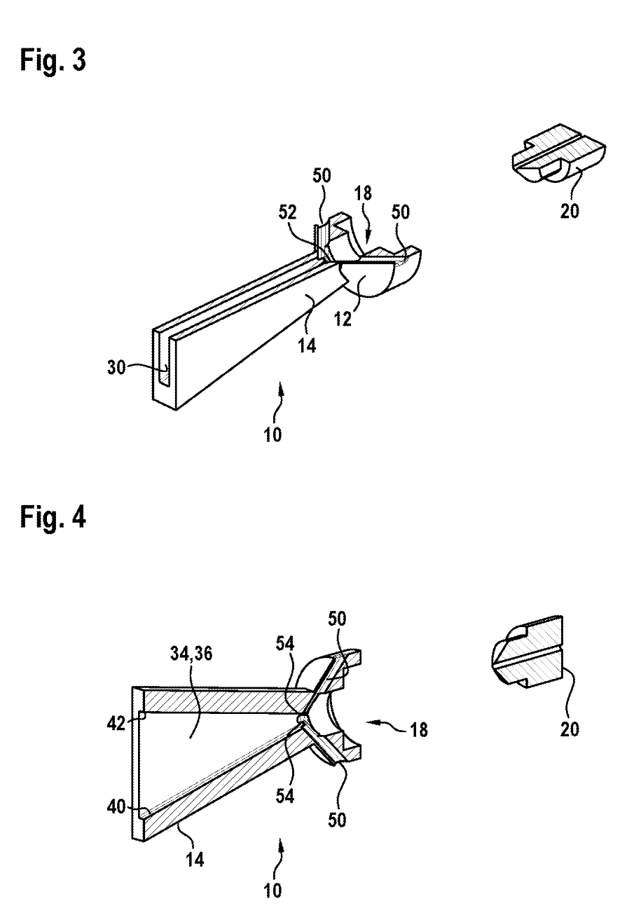

FIG. 3 and FIG. 4 each show the first nozzle attachment assembly 10 from FIG. 1, wherein shown in FIG. 3 is a sectional depiction of the nozzle attachment assembly and the flat jet nozzle 20 along a first plane and in FIG. 4 a second plane that lies perpendicular to the first plane is selected instead of the first plane as the section plane. Due to the selection of the planes, the interior of the nozzle attachment assembly 10 is visible in FIG. 3 and 4. In particular, an opening 52 is visible in FIG. 3 at the transition between the connection element 12 and the jet preservation element 14. At the opening 52, a gas channel, which is not further specified, opens into an expansion zone 30, which is formed in the interior of the jet preservation element 14. This expansion zone 30, as can be seen in FIG. 4, is delimited laterally by side walls 40, 42, wherein the two side walls 40, 42 diverge along the axial direction of extent 24, i.e., the further one moves in the axial direction of extent 24, the further apart from one another they are. This divergence of the side walls 40, 42 is advantageous but optional and may be omitted in this and all other embodiments, even if it is explicitly shown and described in the individual Figures. On the two other opposing faces, the expansion zone 30 is delimited by cover sides 34, 36, such that the expansion zone 30 overall forms a fan-shaped structure, which “originates” at the transition between the jet preservation element 14 and the connection element 12. In FIG. 4, two further opposite openings 54 are visible in the transition region between the connection element 12 and the jet preservation element 14, which also connect gas inlet openings 50 to the expansion zone 30. During the operation of the first nozzle attachment assembly 10, a fan-shaped liquid jet is formed in the interior of the expansion zone 30 by the flat jet nozzle 20, which liquid jet, when flowing past the openings 52, 54, draws in gas via the connection channels 30 from the peripherally arranged gas inlet openings 50 and hereby forms a gas curtain, which envelops the liquid jet in the expansion zone 30 and later when exiting the jet preservation element 14, said gas curtain in particular being in the form of a boundary layer that protects and stabilizes the liquid jet. Thus, the necessary gas for the formation of the uniform gas layer in the expansion zone 30 is provided by way of the gas inlet openings 50.

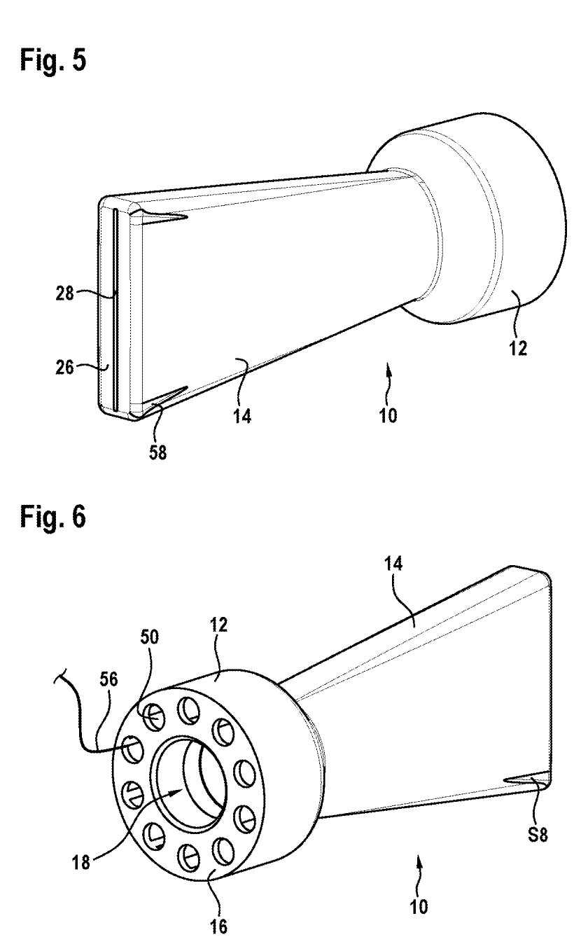

FIGS. 5 to 8 show simplified three-dimensional depictions of a second nozzle attachment assembly 10. The perspectives or sectional views selected in each case correspond to the perspectives or sectional views already known from FIGS. 1 to 4. One visible difference in FIG. 5 between the second nozzle attachment assembly 10 and the first nozzle attachment assembly 10 depicted analogously in FIG. 1 is a stiffener 58 on the outlet-side end of the jet preservation element 14. In particular in the case of a jet preservation element made of an elastic material, this stiffener 58 can advantageously counteract a “pulsating flutter”, as is known, for example, from a loose end of a flexible hose from which liquid is being sprayed. In FIG. 6, it can be seen that in the second depicted nozzle attachment assembly 10, the gas inlet openings 50 are arranged on the connection element 12, in particular on the end face 16 of the connection element 12. The gas inlet openings 50 are thus in the direct vicinity of the coupling point 18, such that optionally the arrangement of the flat jet nozzle 20 on the coupling point 18 is able to be combined together with the connection of a gas supply conduit into one single joint “connection step” or is able to be achieved by one common connection element. Shown in FIG. 6 is a gas supply conduit of that kind, which is configured, for example, as a simple gas-conducting hose, by way of which gas is optionally able to be conveyed in the direction toward the gas inlet openings 50. If a conveyance of that kind is not provided, then during the operation of the nozzle attachment assembly 10 with a flat jet nozzle arranged on the coupling point, the flat jet formed in the interior of the jet preservation element 14 again draws gas through the gas supply conduit 56 according to the principle of the water jet pump. This can be advantageous in particular for an underwater application, wherein the end of the gas supply conduit 56 pointing away from the gas inlet opening 50 may then be held floating on the water surface, for example.

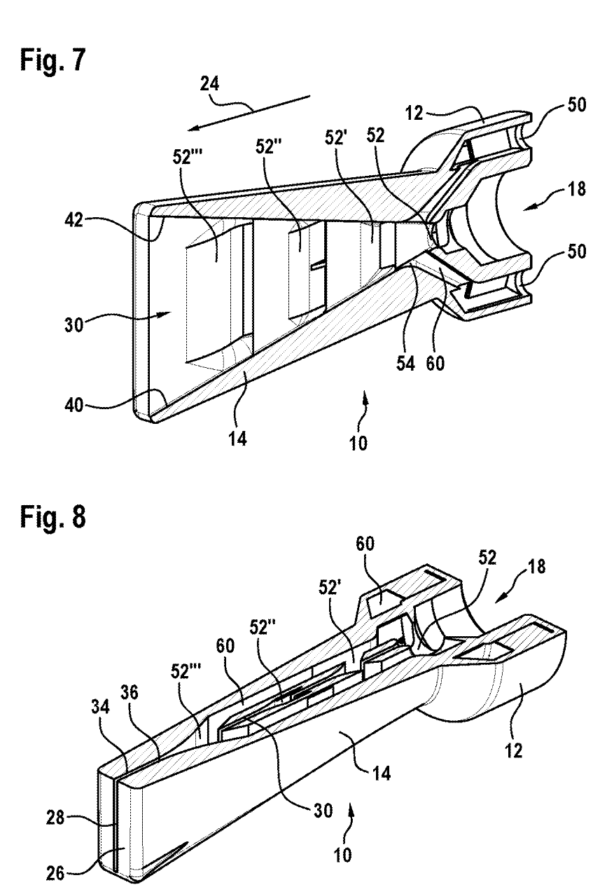

FIGS. 7 and 8 now show the inner structure of the second nozzle attachment assembly 10 in the respective sectional depictions along the first plane and the second plane perpendicular to the first plane. Commencing from the gas inlet openings 50, a branching gas channel structure 60 extends in the interior of the nozzle attachment assembly 10, said gas channel structure connecting a multitude of openings 52, 52’, 52’’, 52’’’, 54 arranged at different positions to the gas inlet openings 50. Again, similarly as in the case of the first nozzle attachment assembly 10 from FIGS. 1 to 4, the openings 52, 54 are arranged on opposite sides at the transition region between the connection element 12 and the jet preservation element 14. In addition, further openings 52’, 52’’, 52’’’ are arranged opposite one another along the axial direction of extent 24 on the cover sides 34, 36 of the expansion zone 30. Said openings 52’, 52’’, 52’’’ further improve the compactness of the flat jet passing through the expansion zone 30 by said formed jet repeatedly drawing in additional gas when passing the respective openings 52’, 52’’, 52’’’, the gas being added to the uniform gas layer around the flat jet. The amount of gas that is drawn in hereby transmits its component of momentum directed toward the liquid jet to said liquid jet, such that the liquid jet is refocused/additionally focused in the outlet direction, i.e., in the axial direction of extent 24. The widths of the openings 52’, 52’’, 52’’’ hereby increase noticeably along the axial direction of extent 24, because the flat jet or the expansion zone 30 replicating it widens along this direction of extent 24. The laterally delimiting side walls 40, 42 diverge. The amount of gas drawn in by the respective individual openings 52, 52’, 52’’, 52’’’, and 54 is dependent on, among other things, the length and the cross-section of the gas channel(s) 60, which connect(s) the openings 52, 52’, 52’’, 52’’’, and 54 to the gas inlet openings 50. Accordingly, a modeling or adaptation of the respective amount of gas drawn in is possible, which can be performed, for example, by experiment or by means of a numerical simulation. Furthermore, an optional web that is not further specified is visible in FIG. 7, said web serving to stiffen the nozzle attachment assembly. The web not further specified is also visible in FIG. 8 in the vicinity of the opening 52’’ and appears to block the opening 52’’. In fact, only the selected section plane lies precisely within the web.

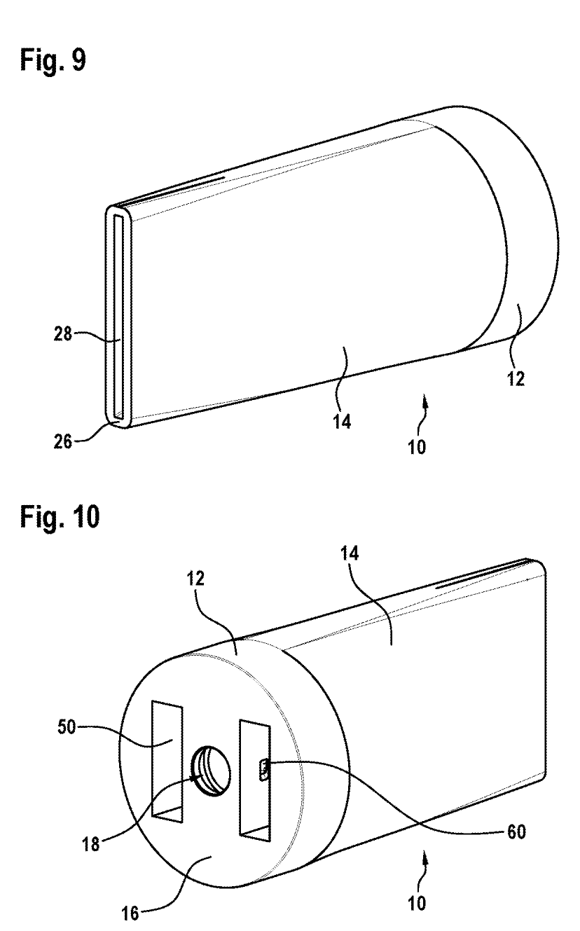

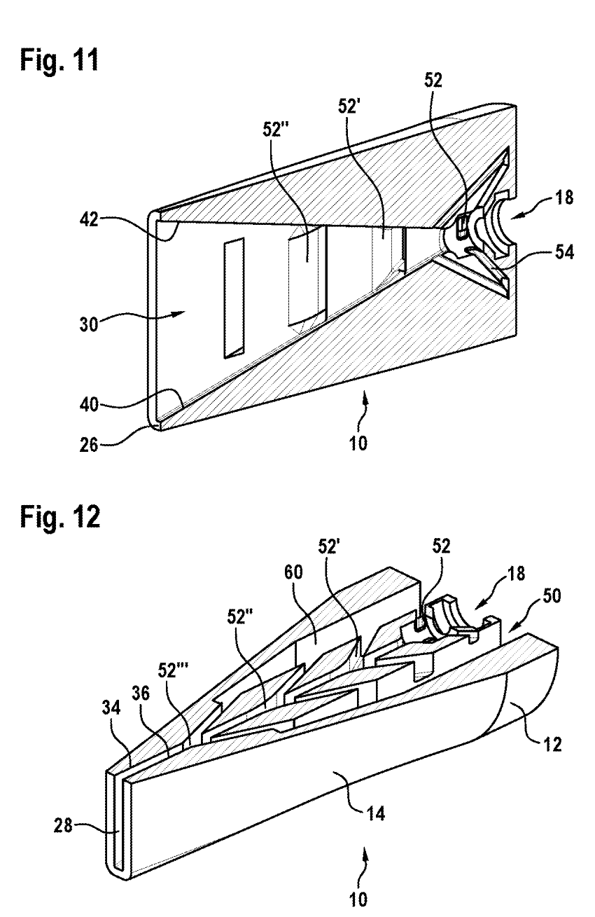

FIGS. 9 to 12 show simplified three-dimensional depictions of a third nozzle attachment assembly 10. The third nozzle attachment assembly 10 depicted in FIGS. 9 to 12 is depicted analogously to the first two nozzle attachment assemblies 10 in the corresponding FIGS. 1 to 4 and 5 to 8 respectively. The third nozzle attachment assembly 10 depicted in FIGS. 9 to 12 is similar in large parts to the second nozzle attachment assembly 10 from FIGS. 5 to 8. Unlike said second nozzle attachment assembly 10, only two elongate gas inlet openings located opposite one another are depicted on the end face 16, which in the interior enable the intake of gas at the openings 52, 52’, 52’’, 52’’’, and 54 by means of appropriate branching, exactly as in the case of the second nozzle attachment assembly 10.

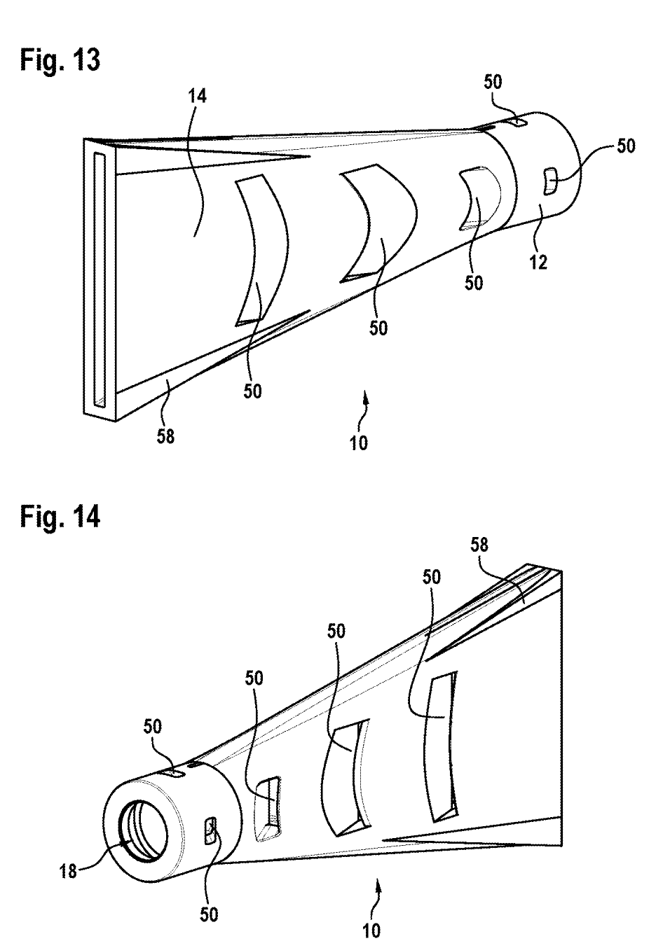

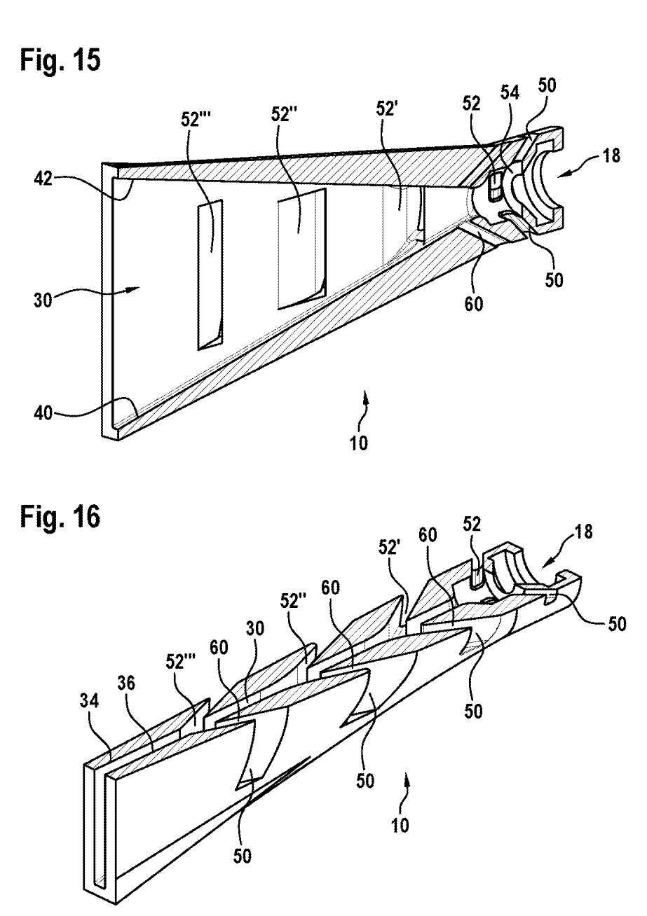

FIGS. 13 to 16 show simplified three-dimensional depictions of a fourth nozzle attachment assembly 10. Analogously to the different nozzle attachment assemblies 10 shown previously in FIGS. 1 to 12, in the case of the fourth nozzle attachment assembly 10, a multitude of gas inlet openings 50 are distributed over the outer surface of the fourth nozzle attachment assembly 10. In particular, gas inlet openings 50 are also arranged on the jet preservation element 14. As can be seen in FIGS. 15 and 16 in the respective sectional views of the fourth nozzle attachment assembly 10 along the first section plane and the second section plane respectively, by means of the additional gas inlet openings 50 a direct connection of different openings 52, 52’, 52’’, 52’’’, and 54 by way of non-branching gas channels 60 is made possible. The resulting gas channels 60 are consequently very short, such that the amount of gas able to be drawn in via the individual gas openings 50 may be large in quantity.

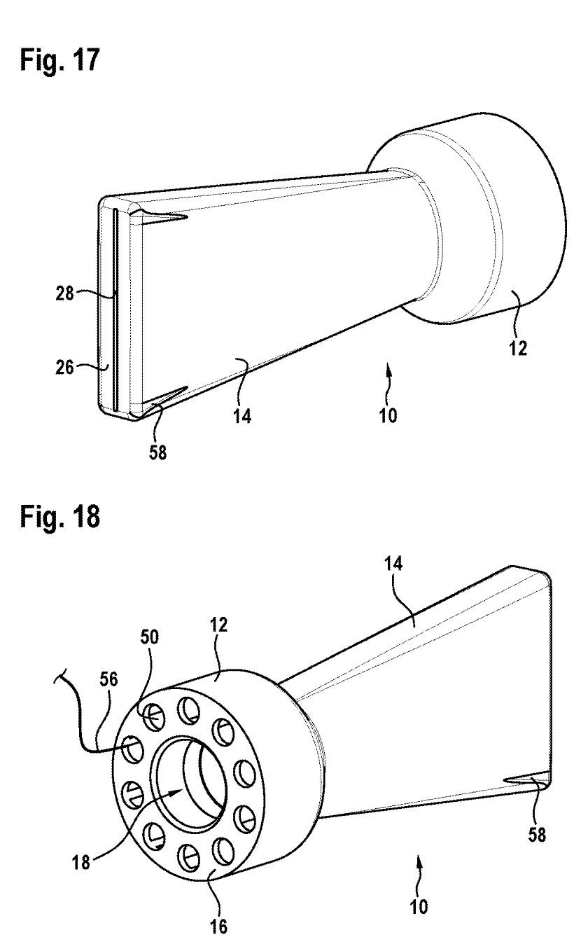

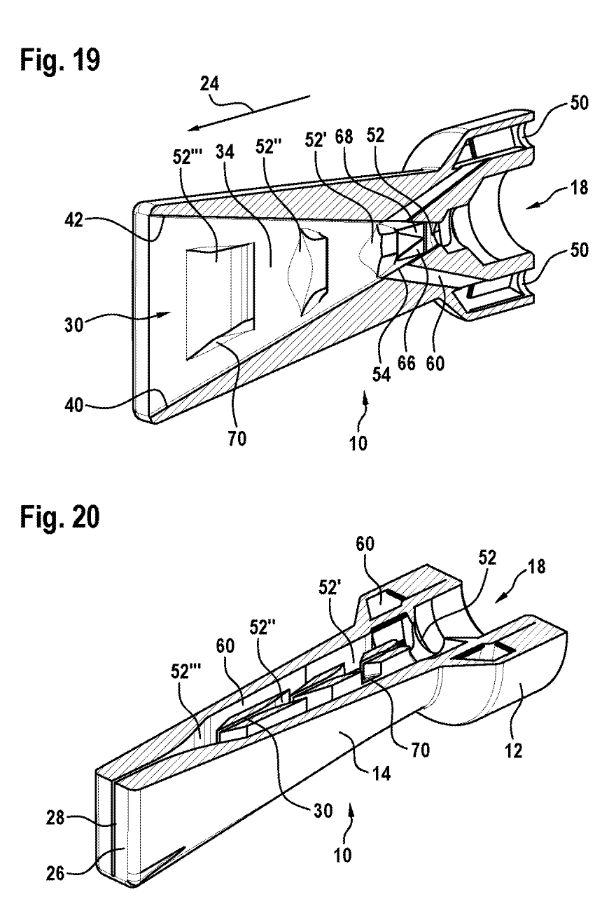

FIGS. 17 to 20 show simplified three-dimensional depictions of a fifth nozzle attachment assembly 10. Here, when viewed from the outside, the fifth nozzle attachment assembly 10 cannot be differentiated from the second nozzle attachment assembly 10 depicted in FIGS. 5 to 8. However, upon studying FIGS. 19 and 20 more closely, which show the inner structure of the fifth nozzle attachment assembly 10, the projection 66 and the further projection 68 on the cover wall 34 catch the eye. The two projections 66, 68 constitute a structure of the cover wall 34, which reduces the otherwise constant distance h between the cover walls 34, 36. Here, it is to be assumed that projections 66, 68 are also arranged on the cover wall 36 that is not visible in FIG. 19, namely symmetrically to the visible projections 66, 68. The projections 66, 68 reduce the gap width between the cover wall 34 and the passing liquid jet, a pressure gradient thereby being created in the uniform gas flow. This pressure gradient is based on the principle of the ground effect and has an attractive or repellent effect on the passing liquid jet, such that said liquid jet is able to be homogenized in thickness over its width, depending on the exact design of the projections 66, 68. After flowing past the projections 66, 68, the liquid jet can thus locally have a slightly altered thickness over its width, which reduces previously existing thickness differences.

The exact position and shape of the projections 66, 68 on the cover walls 34, 36 can be varied as necessary and, in particular, can also be determined/optimized by experiment for a special flat jet nozzle. Here, it is also possible, in particular, that more than two projections 66, 68 are arranged simultaneously at different points on the cover walls.

In the embodiment depicted in FIG. 19, the two projections 66, 68 are configured as triangles, the base surfaces of which adjoin one another and the front tips of which diverge (in the axial direction of extent), such that liquid is “contactlessly” drawn from a central middle region of the flat jet into the two opposite rim regions of the flat jet. Furthermore, altered opening side walls 70 of the openings 52, 52’, 52’’, and 52’’’ are visible (compared to FIG. 8). These adaptations may cause slight changes in the pressure conditions in the homogeneous gas layer and thus may contribute to the homogenization of the flat jet.

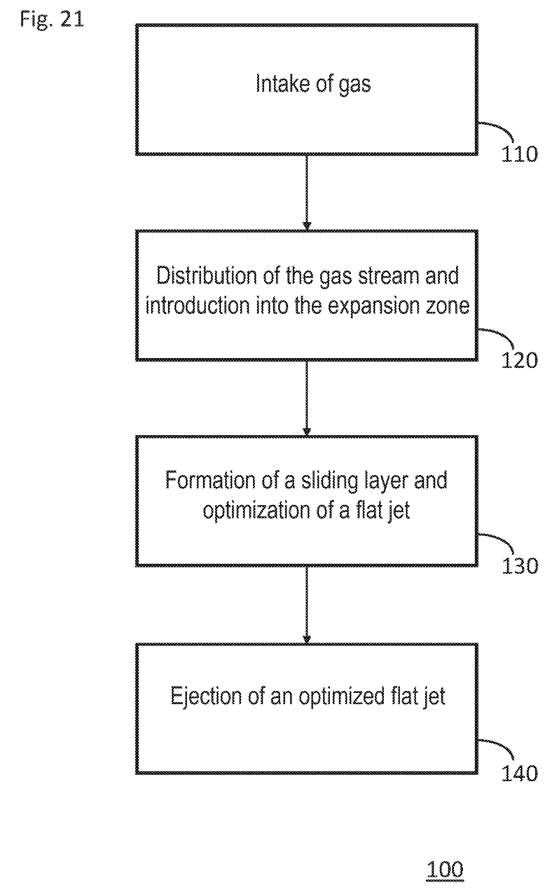

FIG. 21 shows a flow diagram of an exemplary method 100. The method 100 may serve, in particular, for the jet preservation of a liquid jet that is formed by a flat jet nozzle. One of the nozzle attachment assemblies described above can be used in performing the method 100. The method 100 typically begins with an intake 110 of gas via a gas inlet opening by a passing liquid jet, which is a flat jet. Said flat jet may already be fully formed, in particular by a flat jet nozzle. The gas drawn in can then be conducted in a subsequent step 120, a distribution and introduction, first via gas channels to the openings present at the expansion zone of the nozzle attachment assembly and from then can be distributed and introduced into the expansion zone. Then, in a further step 130, a sliding layer between flat jet and side walls is formed and the already formed flat jet flowing by is optimized. The optimization may hereby be understood to mean, in particular, both a compactification (for example in the sense of bundling the liquid jet) and a homogenization (for example in the sense of an equalization of the energy contained in the flat jet). After the flat jet has been optimized and thus preserved, then in a further step an ejection 140 of the optimized flat jet from the nozzle attachment assembly takes place. Thus, this is also the time at which the flat jet exits the nozzle attachment assembly used. Overall, it should be noted here that the liquid jet continuously flows through the nozzle attachment assembly and that the aforementioned sequence of individual steps does not mean that said steps are each performed one after the other. Rather, after an initial phase in which the liquid jet is established, the described steps are performed continuously and simultaneously, but may hereby act on different regions of the liquid jet or be triggered thereby, such that a temporal sequence is more understood in relation to a liquid element moving with the liquid jet.

The features of the invention disclosed in the preceding description, in the drawings, and in the claims may be essential both individually and in any combination for the realization of the invention.

### REFERENCE NUMERAL LIST

10 nozzle attachment assembly

12 connection element

14 jet preservation element

16 end face

18 coupling point

20 flat jet nozzle

24 axial direction of extent

26 outlet side

28 outlet opening

30 expansion zone

34 cover wall

36 cover wall

40 side wall

42 side wall

46 radial direction

50 gas inlet opening

52 opening

52’ opening

52’’ opening

52’’’ opening

54 opening

56 gas supply conduit

58 stiffener

60 gas channel

62 liquid supply conduit

64 flat jet nozzle outlet opening

66 projection

68 further projection

70 opening side wall

100 method

110 intake

120 distribution and introduction

130 formation and optimization

140 ejection

1. A nozzle attachment assembly comprising a connection element having a coupling point arranged on an end face for accommodating a flat jet nozzle of a liquid-operated high-pressure cleaner, wherein a jet preservation element adjoins the connection element along an axial direction of extent of the nozzle attachment assembly, wherein the jet preservation element comprises an outlet opening on an outlet side facing away from the end face, said outlet opening being in fluid-conducting connection with the coupling point by way of the interior of the nozzle attachment assembly, wherein the fluid-conducting connection is configured as an expansion zone, which is delimited in a first plane perpendicular to the axial direction of the extent by cover walls that have a distance h and which is delimited by side walls in a second plane that is perpendicular to the first plane, such that the expansion zone overall replicates a jet geometry of the flat jet nozzle that is able to be accommodated in such a way that a liquid jet formed having this jet geometry is continuously surrounded within the expansion zone by a peripheral gap in a radial direction perpendicular to the axial direction of extent, and wherein at least one of i) the connection element and ii) the jet preservation element comprises at least one gas inlet opening, which opens into the expansion zone.

2. The nozzle attachment assembly in accordance with claim 1, wherein the at least one gas inlet opening is closable or adjustable.

3. The nozzle attachment assembly in accordance with claim 1, wherein the at least one gas inlet opening opens into the expansion zone at at least two openings separated from one another, wherein at least one opening is provided on each cover wall.

4. The nozzle attachment assembly in accordance with claim 1, wherein the at least one gas inlet opening opens into the expansion zone at at least four openings separated from one another, and wherein at least one opening is provided on each cover wall and further at least one opening is provided on each side wall.

5. The nozzle attachment assembly in accordance with claim 1, wherein the side walls diverge in the axial direction of extent, such that the expansion zone widens in the shape of a fan.

6. The nozzle attachment assembly in accordance with claim 1, wherein openings provided on at least one of i) the opposing cover walls and ii) the opposing side walls are each arranged symmetrically to one another in pairs.

7. The nozzle attachment assembly in accordance with claim 1, wherein provided on each of the opposing cover walls in the axial direction of extent are a plurality of openings, the respective width of which increases with increasing distance from the connection element.

8. The nozzle attachment assembly in accordance with claim 1, wherein provided on each of the opposing cover walls is at least one structuring projection, which locally reduces the distance h between the cover walls.

9. The nozzle attachment assembly in accordance with claim 1, wherein gas inlet openings are provided on the end face.

10. The nozzle attachment assembly in accordance with claim 1, wherein the jet preservation element is able to be assembled modularly from a plurality of individual elements, and wherein the plurality of individual elements are connectable to one another in the axial direction of extent.

11. A system comprising a flat jet nozzle, which is set up to shape supplied liquid to form a flat jet having a jet geometry, and comprising a nozzle attachment assembly, which is adapted to said jet geometry and which comprises
a connection element having a coupling point arranged on an end face for accommodating a flat jet nozzle of a liquid-operated high-pressure cleaner, wherein a jet preservation element adjoins the connection element along an axial direction of extent of the nozzle attachment assembly, wherein the jet preservation element comprises an outlet opening on an outlet side facing away from the end face, said outlet opening being in fluid-conducting connection with the coupling point by way of the interior of the nozzle attachment assembly, wherein the fluid-conducting connection is configured as an expansion zone, which is delimited in a first plane perpendicular to the axial direction of the extent by cover walls that have a distance h and which is delimited by side walls in a second plane that is perpendicular to the first plane, such that the expansion zone overall replicates a jet geometry of the flat jet nozzle that is able to be accommodated in such a way that a liquid jet formed having this jet geometry is continuously surrounded within the expansion zone by a peripheral gap in a radial direction perpendicular to the axial direction of extent, and wherein at least one of i) the connection element and ii) the jet preservation element comprises at least one gas inlet opening, which opens into the expansion zone.

12. The system in accordance with claim 11, wherein the flat jet nozzle is formed in one piece with the nozzle attachment assembly.

13. The system in accordance with claim 11, wherein a component of the flat jet nozzle forms a connection element of the nozzle attachment assembly.

14. A method 100 for jet preservation of a liquid jet exiting a flat jet nozzle, wherein the liquid jet is enveloped by a gas curtain using a nozzle attachment assembly comprising
a connection element having a coupling point arranged on an end face for accommodating a flat jet nozzle of a liquid-operated high-pressure cleaner,
wherein a jet preservation element adjoins the connection element along an axial direction of extent of the nozzle attachment assembly,
wherein the jet preservation element comprises an outlet opening on an outlet side facing away from the end face, said outlet opening being in fluid-conducting connection with the coupling point by way of the interior of the nozzle attachment assembly,
wherein the fluid-conducting connection is configured as an expansion zone, which is delimited in a first plane perpendicular to the axial direction of the extent by cover walls that have a distance h and which is delimited by side walls in a second plane that is perpendicular to the first plane, such that the expansion zone overall replicates a jet geometry of the flat jet nozzle that is able to be accommodated in such a way that a liquid jet formed having this jet geometry is continuously surrounded within the expansion zone by a peripheral gap in a radial direction perpendicular to the axial direction of extent, and
wherein at least one of i) the connection element and ii) the jet preservation element comprises at least one gas inlet opening, which opens into the expansion zone.
